(19) United States
(12) Patent Application Publication
(10) Pub. No.: US 2007/0157925 A1
(43) Pub. Date: Jul. 12, 2007

(54) Rescue device for snow avalanche victim

(76) Inventor: Yuriy ShterenBerg, Newton, MA (US)

Correspondence Address: ShterenBerg Yuriy;Apt. 415, 677 Winchester Str., Newton, MA, 02459, US

(21) Appl. No.: 11/329,869

(22) Filed: Jan. 12, 2006

(51) Int. Cl. A62B 18/00; A62B 17/04

(52) U.S. Cl. 128/200.24; 128/201.22

(57) ABSTRACT

A rescue device for a victim buried in snow because of snow avalanches, providing connection the victim with outside fresh air for breath, withdrawal and neutralization of exhale air and signaling position of the victim under the snow. The device includes an air canal—telescoping flat-spring structure that drills a hole in snow and connects the victim with open air above the avalanche. The canal includes immobile and moveable housings having hinge connections to outside and inside spires of the spring, accordingly. A blade removing the snow, when the canal is being created, and intensifying movement of the air inside the canal, is attached to a shaft of the electric motor, which in turn is attached to the moveable housing. The blade has a cover avoiding penetration of the snow inside the canal. The device includes also a mask which protects the victim's face from injury, and provides separation of inhaul and exhaust air flows A lamp and a means emitting radio signals placed at the top of the moveable housing generate information about location of the victim. A units located within the immobile housing provide control and electricity supply for the device.

### FIELD OF THE INVENTION

The present invention is related to an avalanche survival assembly to be worn by user, providing prolongation of life necessary condition for a user buried in snow from result of a snow avalanche, and facilitating discovery of the user under the snow. More particularly, it is related to a device providing a long-time fresh air breath for the user buried in snow, and effective signaling the place where the user is buried.

### BACKGROUND OF THE INVENTION

Snow avalanches are not rare natural disasters. Each year it is registered about 2,000 alarms for the avalanche only in Colorado. In the USA and Canada, about 40 people annually buried in snow and die because of snow avalanches.

Researchers affirm that people buried in snow in result of an avalanche, even if they are not seriously injured, remain alive in buried conditions for approximately 15-30 min. Death comes due to suffocation caused by exhaust carbon dioxide. This gas is accumulated in the surrounding environment, which is a source for air required for people to breathe, and gradually poison the air. Another problem is difficulties in quick finding people who are buried in snow. In many cases it takes more then 15-30 min that a survivor really has.

At present, it is developed and patented a number of devices providing people buried in snow with quality breath and thus, extending their life under the buried conditions. The examples of such prior art devices as U.S. Pat. Nos. 6,412,482; 6,000,395; 5,490,501; 4,964,405; 4,365,628; 4,062,359. Some devices include means signaling buried position of the people. These developments can be grouped the following way:

The first group includes the devices having an oxygen supply means, usually oxygen balloon, connected to a system that delivers the oxygen to the breath organs of the avalanche victim. A typical example of this approach is disclosed in the U.S. Pat. No. 6,412,482, 128/204 “Avalanche survival pack assembly” by Rowe. To maximize time for breath, the device deliver to the victim controlled amount of oxygen in a pulsating mode. Exhaust air passes through an carbonic acid absorbing means. Invention includes also a radio signal transmitting beacon and a color ribbon as an additional means for indication location of avalanche victims. The major drawbacks of the devices of this type are: a relatively large balloon with oxygen that user must carry on when he/she enter an avalanche-potential area, is very inconvenient and potentially restrictive for regular physical activities of the user. The worst thing, according to description of the device, it supplies avalanche victims with life-sustaining oxygen for no more then one hour, which may be not enough for survivor.

The second group includes devices having means providing usage of an oxygen contained in snow surrounding buried people. A typical example of this approach is disclosed in the U.S. Pat. No. 5,490,501, 128/204 “Avalanche victim's air-from-snow breathing device” by Crowley. The device includes inhalation and exhalation chambers, each of which is connected to a mask put on the victim's face. The mask includes a net-like membrane(s) capable to pass the air in (inhalation) and out (exhalation) of the mask. The major drawbacks of this system are: the exhaust air passing the net-like membrane warms the membrane and melt surrounding snow. The melted snow will convert into ice on the membrane surface, and thus dramatically reduce or even null membrane's penetration for the air.

The main object of the present invention is to overcome the above drawbacks of the prior art devices, i.e.

To prolong appreciably period of time when avalanche victim is supplied with fresh air,

To increase the efficiency of signaling about location of the avalanche victim,

To diminish relatively large inconvenient elements of an avalanche surviving device, which a user should carry on permanently during avalanche-potential situation.

### DISCLOSURE OF THE INVENTION

The present invention achieves the above objectives, among others, by providing an air connection between avalanche victim and air space above a snow avalanche with the help of an air channel; the air channel in preferred embodiment has a spring shell which one turning into compressed position to extended position drills thickness of snow; an electrical driving means helps fulfilling this job and adds fresh air to natural ventilation of the air channel; a face mask separates flows of breath and absorbs of carbonic acid; the appearance over avalanche the metallic tube of air channel shell and radio and light beacons makes the disclosure of buried victim easier.

### BRIEF DESCRIPTION OF SEVERAL VIEWS OF THE DRAWINGS

FIG. 1a and FIG. 1b are schematic projections of an air channel in compressed position,

FIG. 2 are schematic views of a plate before it had been rolled up into spring and of longitudinal section of a shell's fragment of the air channel,

FIG. 3 is a schematic view of the device during air channel rises up,

FIG. 4 are schematic projections of a driving means's blade,

FIG. 5 is an electric block scheme of the device,

FIG. 6 is a schematic drawing of dressed in a man's head face mask,

FIG. 7 is a schematic drawing of an apron,

FIG. 8 is a schematic drawing a victim during of using of the present invention.

### DETAILED DESCRIPTION OF THE INVENTION

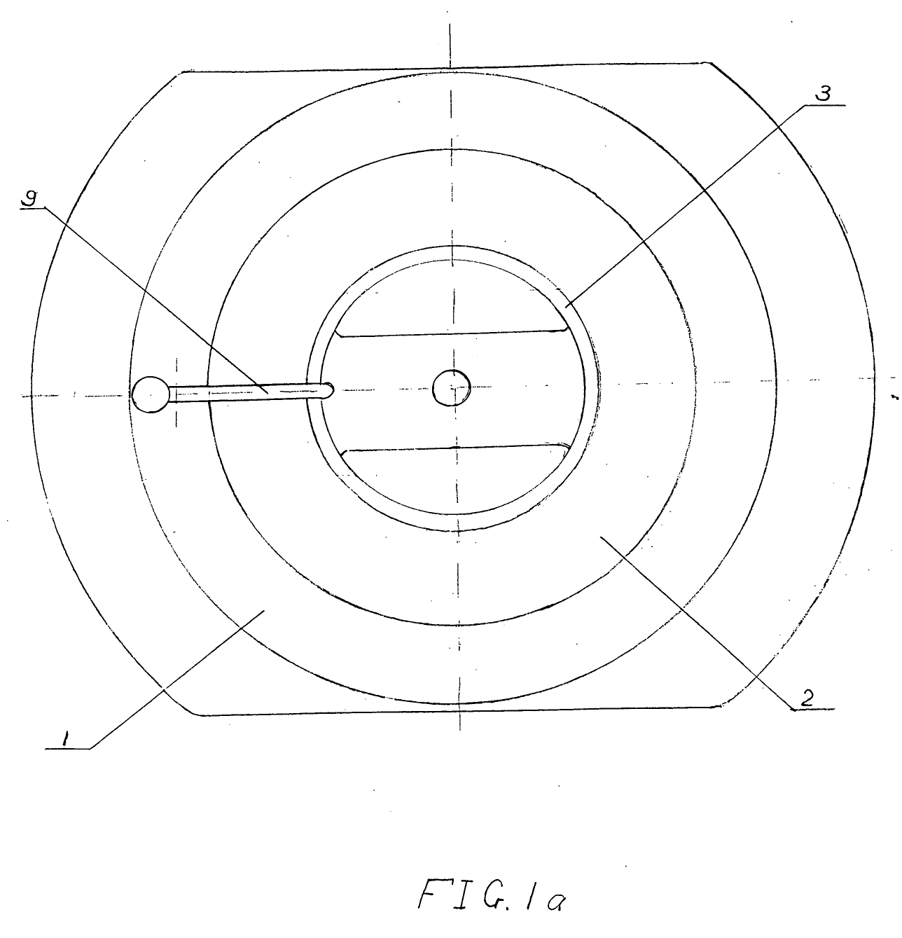

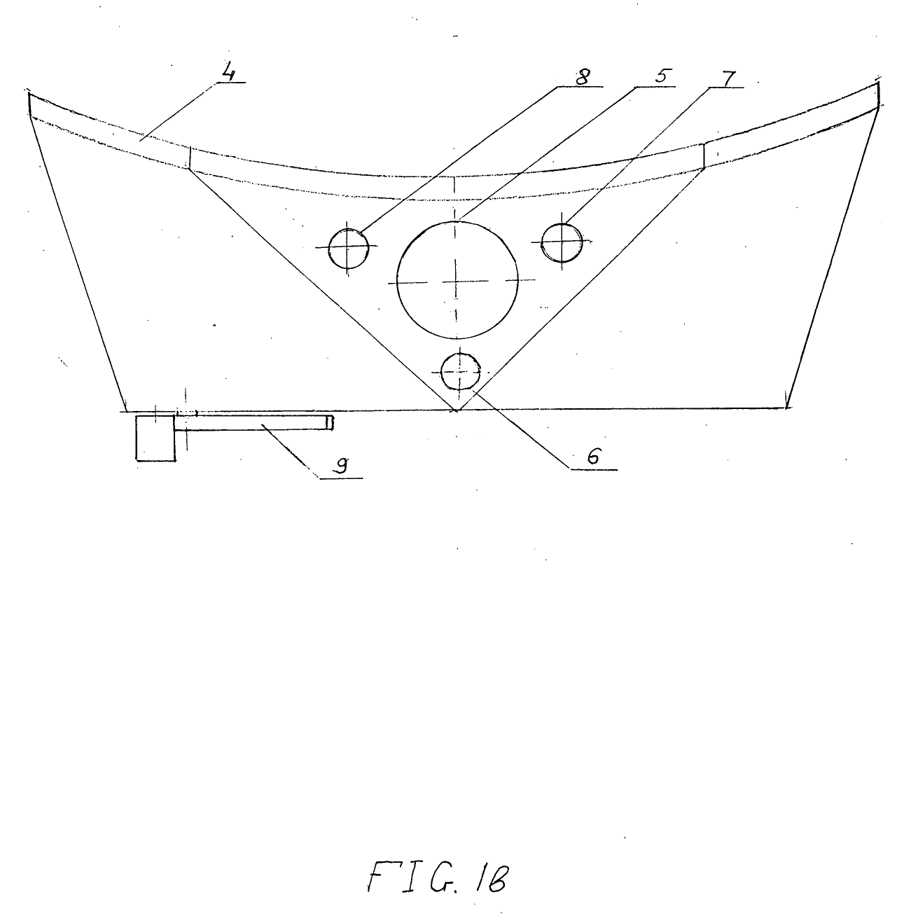

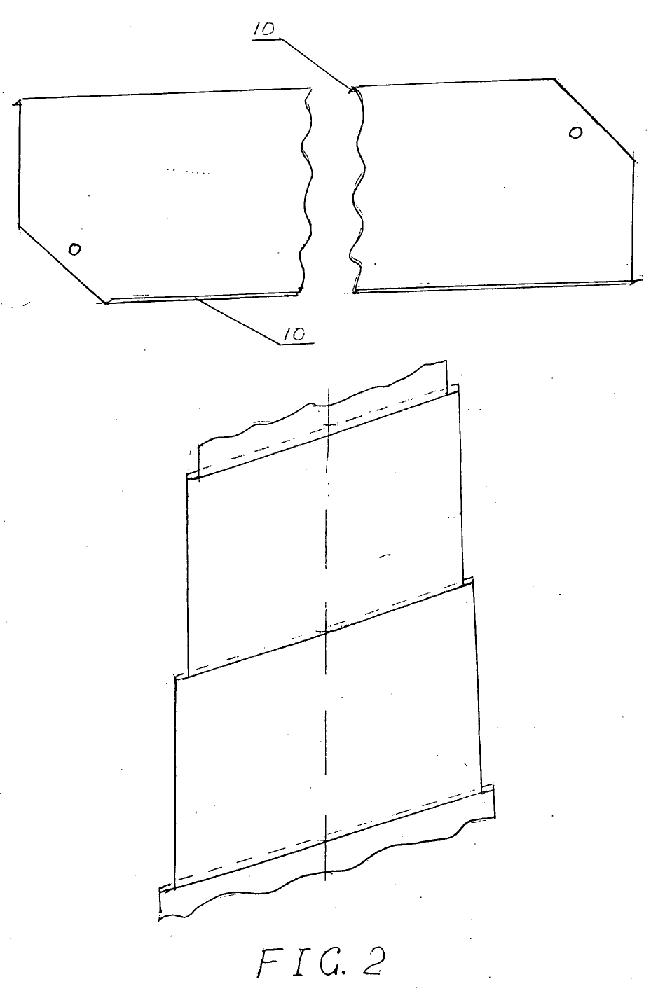

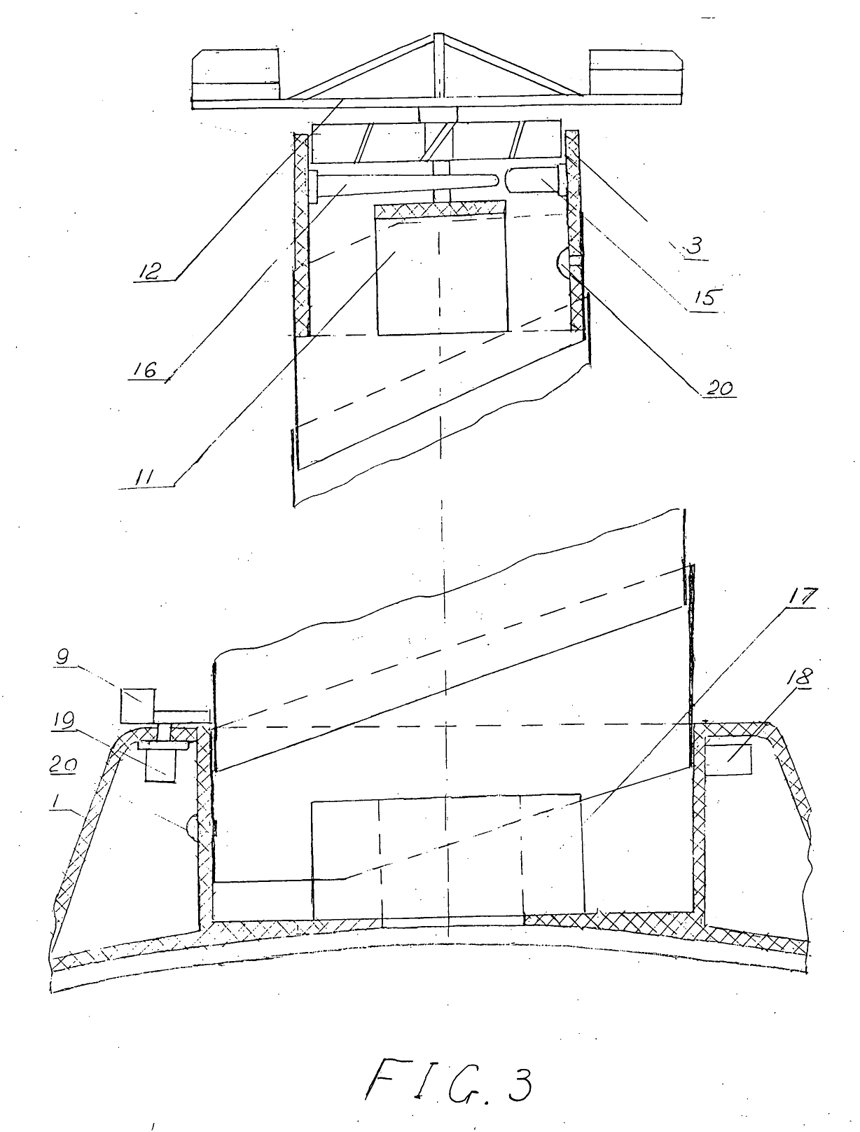

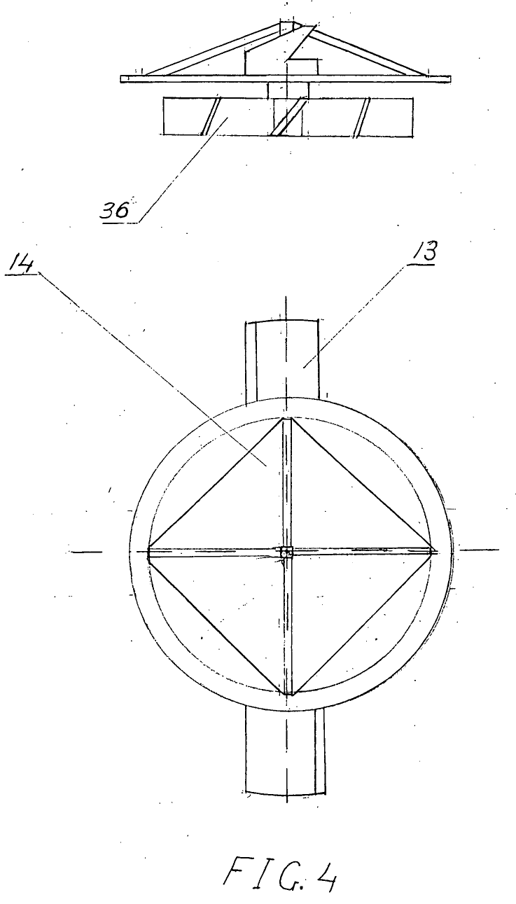

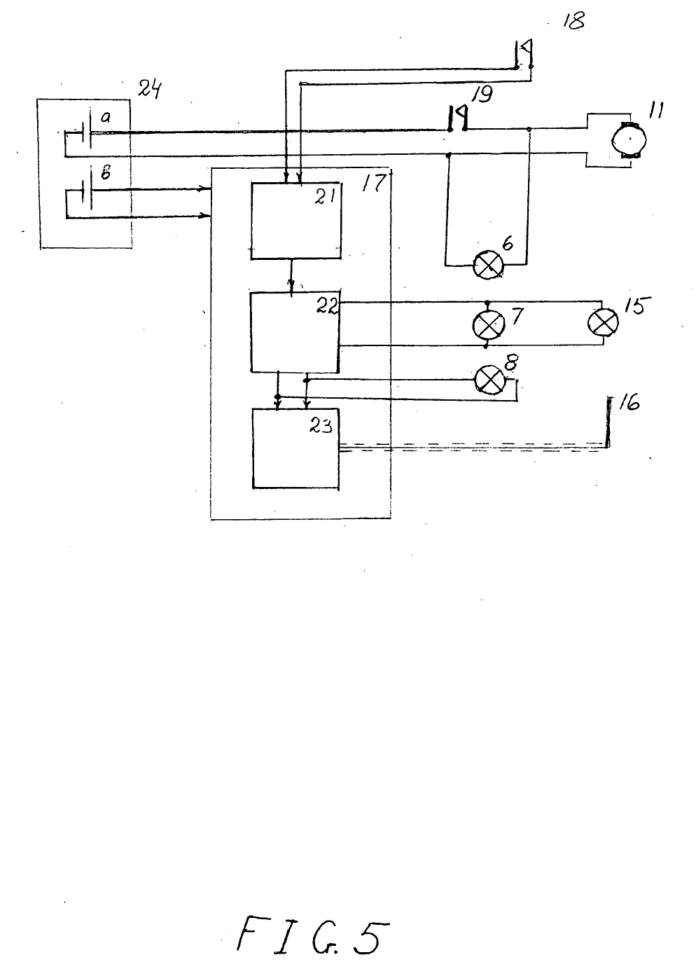

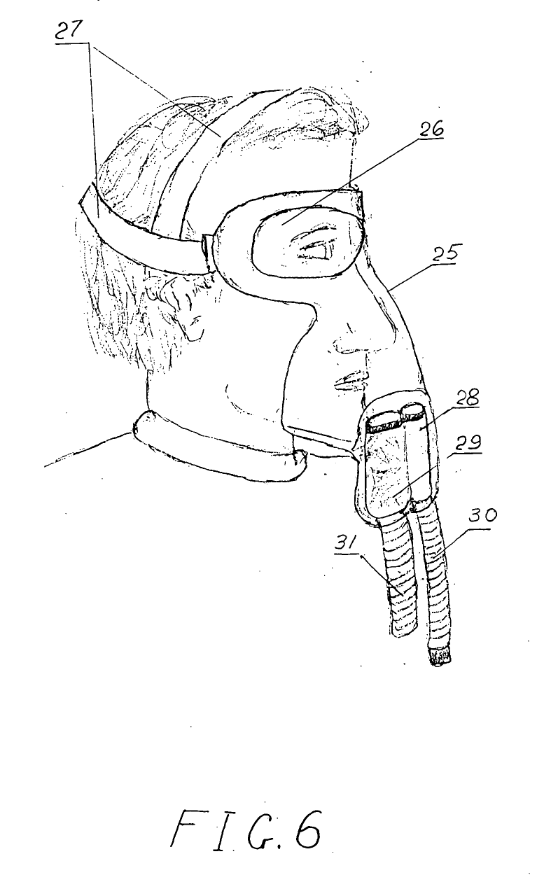

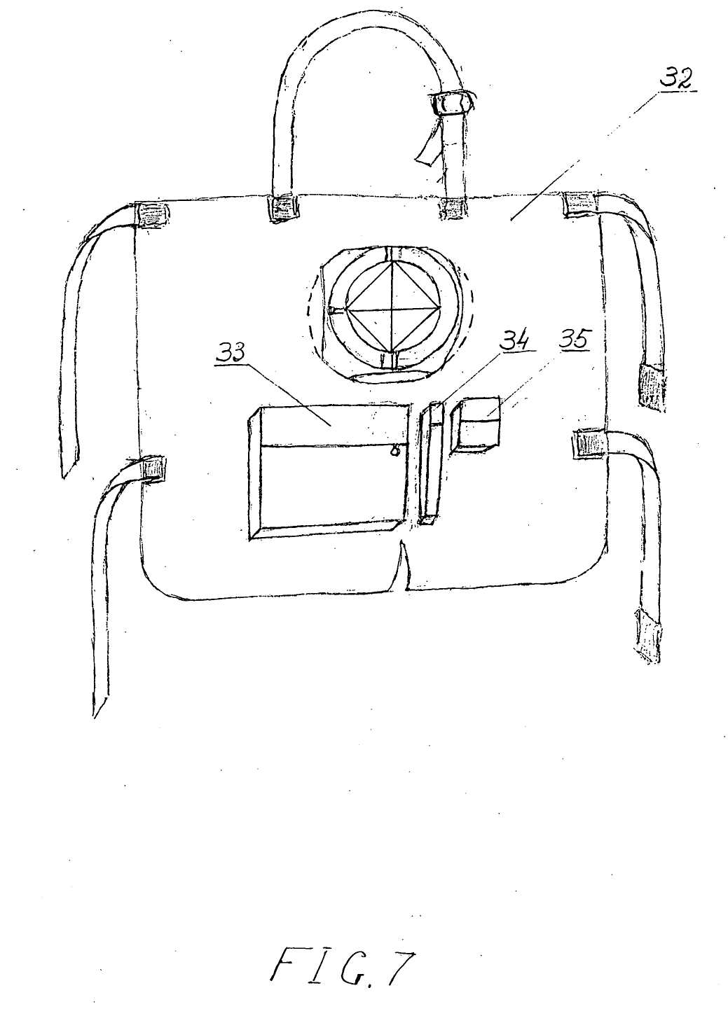

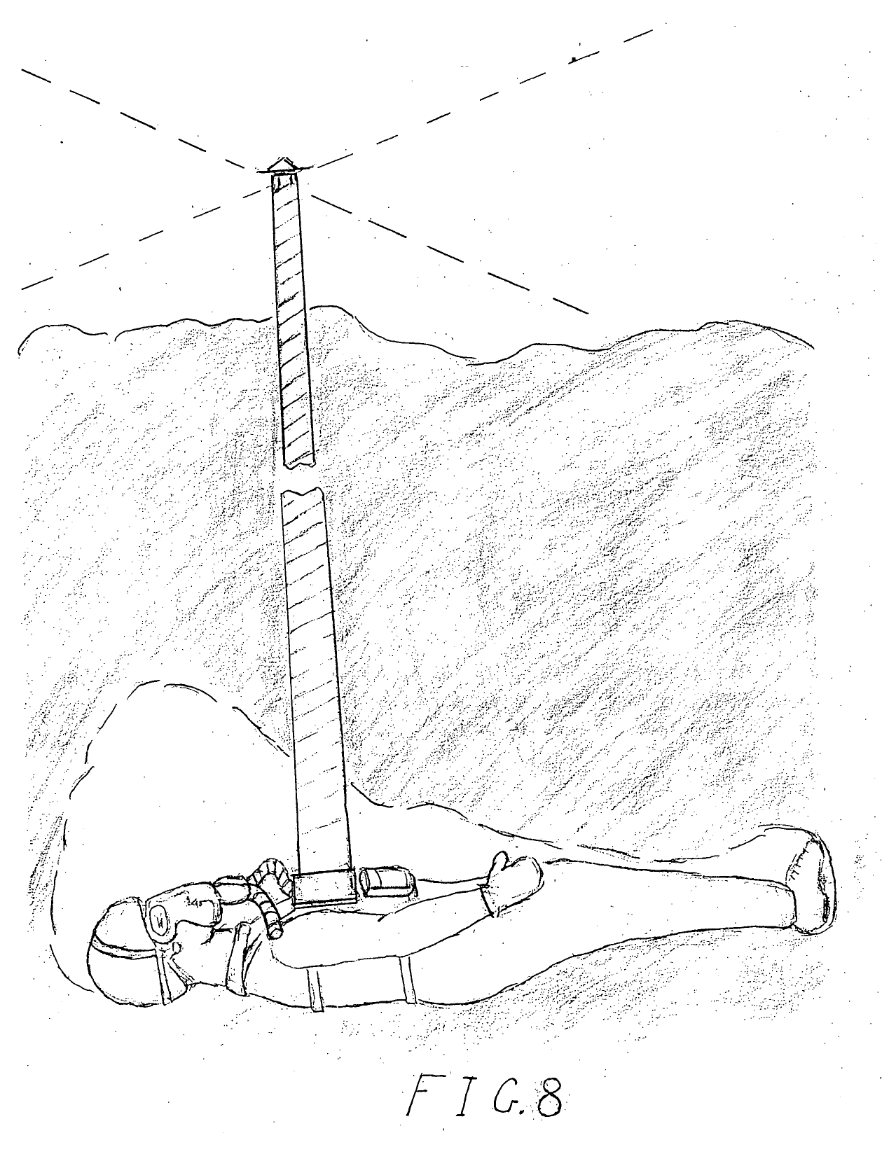

A preferred embodiment of a rescue device for snow avalanche victim of the present invention is illustrated in FIG. 1a, FIG 1b, FIG. 2, FIG. 3, FIG. 4, FIG. 5, FIG. 6, FIG. 7, FIG. 8.

An air channel connecting victim's environment with air space under avalanche is made up on the base of a spring shell consisting of a spring plate. Projections of the main part of the air channel in compressed position are showed on FIG. 1a and FIG. 1b. Here there are: 1-immovable plastic housing having conic outside surface of which top and two opposite side are cut; 2-spring, outside spire of which is adjacent to inside cylindrical surface of housing 1 and inside spire is adjacent to outside cylindrical surface of a movable housing 3. The housing 3 is made up from transparent plastic. The surface of housing 1 that adjoin human's body is rounded off and has soft packing 4. Cutting surface of the housing 1 that is directed to the human's head has inlet 5 for connecting branch pipe of a face mask and three control lamps showing: 6-red, about electric motor's work, 7-whit, about light signaling, 8-blue, about radio signaling. To keep the spring in compressed position and start rising of the air channel a stopper 9 is used.

The spring (FIG. 2) is made from thin-walled (for example, 0.01 mm) wide (for example, 50 mm) plate of high-alloy tempered steel. Tempering of plate is carried out before it had been rolled up. At the edges of the plate there are beadings 10—in different sides on different edges—that fix interposition of spires of the spring when the spring extends and provide stickiness formed conic tube which is a shell of air channel. Longitudinal section of fragment of completely pulled out tube when beadings touch each other is shown also on FIG. 2.

During straightening the spring drills a hole in snow and free tube's end of the air channel together with movable housing 3 move in direction to air space above avalanche. At straightening the spring have to turn relatively housings. To provide this ability, both ends of the spring have hinge connections 20 (FIG. 3) to housings. In order to intensify moving the air channel through snow the device has additional driving means fixing on the movable housing 3 and consisting of an electric motor 11 with reducer and a blade means 12 attached to a motor's shaft. The blade means 12 (FIG. 4) consists of a cutter 13 with a cover 14 and an impeller 36. The cutter and the cover while rotation cut and throw away snow and thus promote moving of air channel through thickness of snow. The cover also protects the air channel from penetration of snow inside the channel. After air channel's top is gone out of the snow surface, a load of the electric motor decreases so speed of its rotation increases, the fan begins to work more effectively and victim gets more fresh air. In the movable housing there are also facilities providing information about location of the avalanche victim such as a light lamp 15 and a radio antenna 16. A control 17 and an electricity supply units of the device are placed in the housing 1. An end switch 18 snaps into action when rising of the air channel is finished. A contactor 19 combined with the stopper 9 switches supply to the electric motor 11.

The electrical block scheme (FIG. 5) explains working of described electrical means. Simultaneously with turning of stopper 9 normally open contact of a contactor 19 is enclosed and the electrical motor 11 begins to work. When creation of the air channel is finished, the end switch 18 snaps into action and its normally open contact starts work of a time's block 21. This one via a switchboard 22 links up electrical supply in turn in a specified period to a signal light lamp 15 and a transmitter 23. Small-size battery 24a provides supply to the electrical motor 11 and the same battery 24b provides supply to control unit 17 and signaling means. If it will be needed, victim can replace of the batteries by spares.

The face mask 25 (FIG. 6) includes a spectacles 26, a belts 27, and a respiration's block consisting of a channel of inhalation 28 and a channel of exhalation 29. Each channel ends to a flexible branch pipe. The channel of inhalation has the connecting branch pipe 30 and the channel of exhalation, containing absorbent of carbonic acid, has the exhaust branch pipe 31 having different diameters to exclude their mixing up. At inhalation, a valve of channel 28 is opened and a valve of channel 29 is closed, but at exhalation, positions of channel's valves is changed on inverse. In this way air flows are separated and inhaled fresh air doesn't mix with exhaled air.

An apron 32 (FIG. 7) is clothed over ski suit by skier or other user who is normally in ski area having a great possibility of avalanche danger. The device, the completely equipped air channel, is fixing in central part of the apron. Apart from, the apron has pocket 33 for the face mask, pocket 34 for a flash-light with attached lace, and pocket 35 for two spare batteries.

When a victim has found himself under an avalanche and has made sure that he cannot get out from snow by himself, he makes the decision to use the rescue device for a snow avalanche victim. For that he dresses in face mask, creates by his body, hands and feet around himself a cavity, by using the switched on flash-light with attached lace as a plummet orientates oneself in space, lies down on his back keeping his face up, and stretches out his feet. Then victim turns out stopper 9 and by ignition of the red control lamp 6 he is sure that process of rising of air channel begins. After that he inserts end of the connecting branch pipe 30 of the mask into the inlet 5 of the immovable housing 1 and lays the exhaust branch pipe 31 so that its end isn't closed by the snow. Alternate ignition and extinction of white 7 and blue 8 control lamps indicates that process of rising of air channel is over and emanation of light and radio signals begins. Ignition at that moment of the red control lamp means that the fan works normally. Extinction of the red control lamp, what may happen after a few hours working of the device, means that it is necessary to replace the battery 24a. So it is necessary to replace the battery 24b if the white 7 and the blue 8 control lamps cease to light up. In the presence of the flash-light those replace operations fulfil easily. By itself the appearance over avalanche the shell of the air channel, the metallic tube, make easier disclosure by rescuer of buried man by using, for example, radio-location sets. Proposed in this invention device and a buried victim in process of expectation of saving ones life are shown conditionally on FIG. 8

1. A rescue device for snow avalanche victim, including: a mask, an air canal, a driving means, a signaling means, energy supply means and a controlling means,
a) Said air canal connecting said victim with air space above said snow avalanche.
b) Said canal having a shell including a spring means, capable of compressed or extended positions, connecting said victim with said air space.
c) Said device having an immovable housing accommodating said spring means in its compressed position, said housing having hinge connection to said spring means.
d) Said device having a movable housing which is wound around with said spring means, having hinge connection to said spring means, moving together with said spring means when said springs means is being extended.
e) Said driving means attached to said movable housing, including an electric motor and a blade means attached to a shaft of said motor.
f) A mask protecting victim's face from injury and providing separation of inhale and exhale air flows, includes valves separating said flows, further includes a tube for the inhaled air flow, attached tightly to said immovable housing, and a tube for exhaled air flow, containing absorbent of carbonic acid, opened toward space surrounding victim.
h) A means emitting radio and light signals, said means being attached to said moveable housing such that they extend out of the snow surface when said spring means is extended, providing information about location of the avalanche victim.

2. A device according to claim 1, wherein said spring means is a flat spring having beadings at its edges, fixing interposition of spires of said spring when said spring extends.

3. A device according to claim 1 having a stopper attached to said immovable housing, holding said spring in wound position, capable of releasing the spring that leads to extension of said spring and creation of said canal.

4. A device according to claim 1, wherein said blade includes two parts: one part drills the snow when said spring extends which creates said cannel and protects the cannel from penetration snow inside the cannel; another part of said blade is a fan intensifying movement of the air inside the canal.
